(19) United States
(12) Patent Application Publication
(10) Pub. No.: US 2010/0032501 A1
(43) Pub. Date: Feb. 11, 2010

(54) Water mist generating head

(76) Inventors: Antoni Tarnogrodzki, Warsaw (PL); Ludomir Duda, Magdalenka (PL); Bohdan Habich, Warsaw (PL); Ryszard Grosset, Marki (PL)

Correspondence Address: FAIER & FAIER P.C., 566 W. ADAMS ST., SUITE 600, CHICAGO, IL, 60661, US

(21) Appl. No.: 11/569,873

(22) PCT Filed: Dec. 3, 2004
(86) PCT No.: PCT/PL04/00101

§ 371 Date: Oct. 16, 2009

(30) Foreign Application Priority Data
May 31, 2004 (PL) P.368269

(51) Int. Cl. B05B 1/14

(52) U.S. Cl. 239/422

(57) ABSTRACT

Water mist generating head comprises a twin-flow body with water and gas manifolds, axially symmetrical gas nozzles and annular water port, concentrically situated between the nozzles. The water port has a water nozzle at the outlet, convergent towards the axis and gas nozzles, central and outer annular, having a Laval nozzle profile with outlet channel with walls parallel to the axis. The head is designed for the purpose of extinguishing fires and deactivation of chemical and biological contamination.

The subject of the invention is a head for water mist generation for the purpose of extinguishing fires and deactivation of chemical and biological contamination.

Fire-hose nozzles for generation of water mist, with twin-flow head, where interaction of the two phases—liquid and gas takes place inside the head, are known. The gas of high kinetic energy supplied through a gas manifold, provides pneumatic atomization of a liquid stream or film at the outlet of the water port.

In single stream pneumatic atomizers, one gas-stream of any shape acts on one liquid stream. In multi-stream atomizers, liquid stream flowing through an annular passage is surrounded from two sides with gas stream or the gas stream interacts with liquid streams. [Z. Orzechowski, J. Prywer, “Rozpylanie cieczy” (“Atomization of Liquids”), Section IX, page 211, WNT, Warszawa, 1991].

Known are gasodynamic atomizers for water mist generation, with Laval nozzle. The nozzle has a through passage with a cross section area initially decreasing to a throat, and then increasing in the direction of the nozzle outlet. Such nozzle section profile may be obtained through shaping a portion of the nozzle inside surface or through placing a divergent-convergent part inside the nozzle.

In water mist generation heads, currently used in fire-fighting and chemical recovery, there are serious problems in providing the droplet stream with adequate kinetic energy. As the mist quality improves with the reduction of droplet weight, it is necessary to increase the discharge velocity to increase the energy. At the same time, to obtain sufficiently small droplet diameter, the water stream must discharge through very small holes or break-up on dispersing devices. If, following such processes, the droplets are to have significant speed, it is necessary to use very high pressures as propellant. However, the range of mist fire hose nozzles, in current use, is limited and, in principle, does not exceed 4 to 5 meters. The objective of the solution is the development of a water mist generating head with higher output and range.

Water mist generating head having a twin-flow body with gas and water manifold, axially symmetrical gas nozzles and annular water port, concentrically situated between the nozzles, according to the invention is characterized by the water port that is provided at the outlet, with a water nozzle, convergent to the axis and the central and annular outer gas nozzles have a section of Laval nozzle profile with an outlet channel, having walls parallel to the axis.

It is advantageous if the water port is formed by a sleeve fixed to the body, constituting the inner part of the outer annuar nozzle. The sleeve is terminated, at the outlet, with an inside tapered surface, convergent to the axis, and cylindrical surface behind the convergent-divergent part formed on the outside surface. The water port is provided, on the circumference of the inlet part with radial channels connected with the water manifold. The water manifold has, at least, two inlet holes connected with the radial channels by lateral channels.

In the advantageous version, the central nozzle has a cylindrical outlet channel behind the convergent-divergent part formed on the inside surface. In this version, each gas nozzle, central and outside annular nozzle, has an outlet to throat cross section area ratio of 1.5 to 2.5. Moreover, the throat cross section areas of the outer annular nozzle and the central nozzle are equal, what is advantageous, with a tolerance from 0.8 to 1.2 of the cross section area.

In another version, the central nozzle has an annular central outlet channel, whilst a divergent-convergent part with cylindrical outside surface is concentrically located inside the central nozzle. It is advantageous that, if the divergent-convergent part constitutes a circular nozzle with Laval nozzle profile, with an outlet channel having walls parallel to the axis. In such version of the central nozzle, the cross section area of the circular nozzle throat is advantageously equal to the central nozzle throat cross section area, with a tolerance of 0.8 to 1.2 of the cross section area. It is also advantageous if the circular nozzle has a ratio of outlet and throat cross section areas of 1.5 to 2.5, and the circular nozzle has a ratio of outlet and throat cross section areas of 5 to 8, and the outer annular nozzle has an outside outlet to throat cross section area ratio of 1.5 to 2.5. Moreover, the cross section area of the outer annular nozzle throat is advantageously twice larger than the sum of cross section areas of the central nozzle throat and the circular nozzle throat with a tolerance of 0.8 to 1.2 of the cross section area.

According to the invention, the head allows obtaining a very high degree of water atomization, below 200 microns, high delivery of atomized liquid and considerable range of mist generated of about 8 to 10 meters. The head features a high fire suppression and extinguishing capabilities, ABCE categories, protection of the fire area and of fire site and smoke absorption. The head allows also effective deactivation of large areas of chemically or biologically contaminated land and also spraying liquids of other specialist applications.

The head, as per invention, is shown in the illustration in an examplary version, where

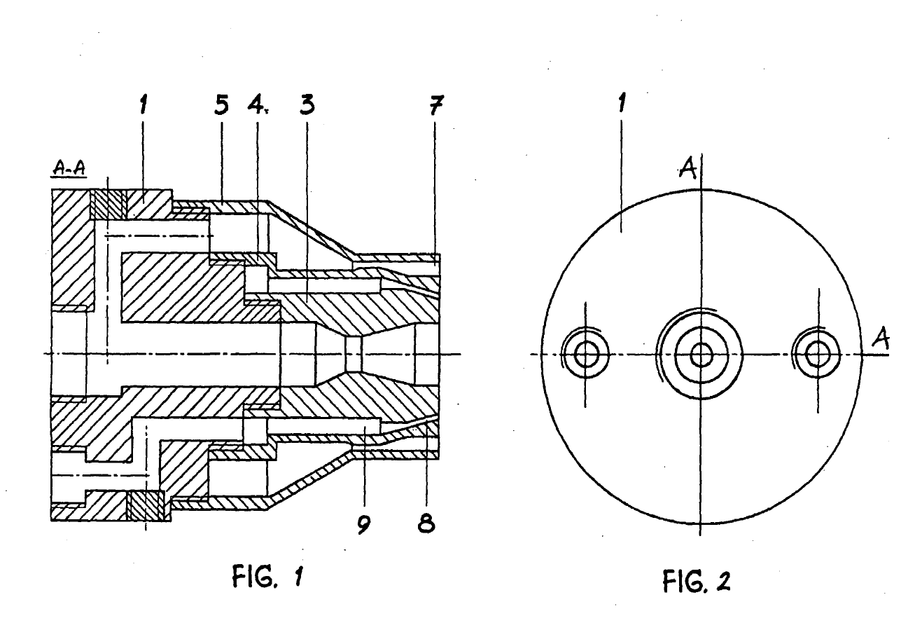

FIG. 1 shows the head in a offset axial section,

FIG. 2—view of head from FIG. 1 seen from inlet manifold end, and

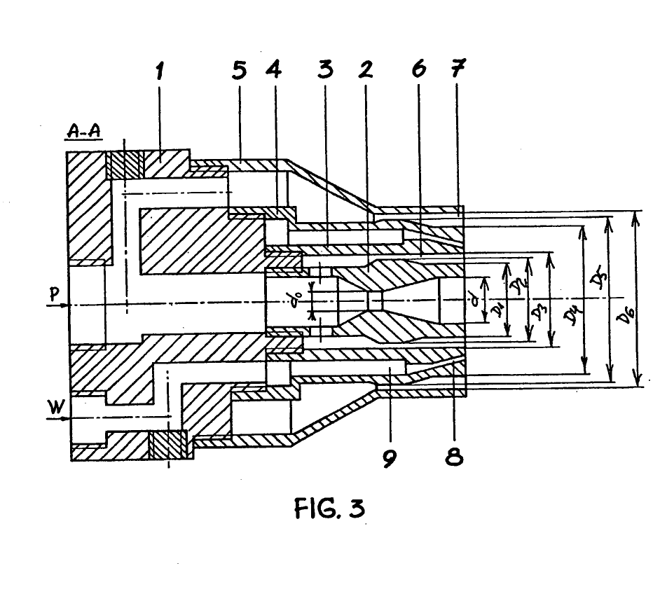

FIG. 3—another version of the head in axial offset section.

Water mist generating head has a twin-flow body 1 with gas and water manifold, axially symmetrical gas nozzles and annular water port 9 , concentrically situated between the nozzles. Water port 9 has water nozzle 8 at the outlet, convergent to the axis, and gas nozzles, central 3 and outer annular 5 have a Laval nozzle profile with an outlet channel with walls, parallel to the axis. Water port 9 consists of sleeve 4 fixed to body 1, constituting the inner part of the outer annular nozzle 5. Sleeve 4 is terminated at the outlet with an inner tapered surface, convergent to the axis and with a cylindrical surface behind the divergent-convergent part, formed on the outside surface. On the circumference of its inlet part, water port 9 has radial channels connected to the water manifold. The water manifold has at least two inlet holes connected with radial channels through lateral channels.

In version presented in FIG. 1, central nozzle 3 has a cylindrical outlet channel, behind the convergent-divergent part, formed on the inside surface. In this version, the central nozzle 3 and outer annular nozzle 5 has an outlet and throat cross section area ratio of 1.5 to 2.5. Moreover, cross section areas of outer annular nozzle 5 throat and central nozzle 3 throat are advantageously equal, with a tolerance of 0.8 to 1.2 of cross section area. Head body 1 has the shape of a stepped cylinder with external thread on the three steps. Central nozzle 3 is screwed onto the first step, of the smallest diameter. Onto the next threaded step, sleeve 4 is screwed. The outer annular nozzle 5 is screwed onto the third step. Nozzle 5 at the inlet, is connected by means of a branch union with the axial channel in body 1, connected with the gas manifold.

Water is supplied to water port 9 via a lateral manifold, lateral channel and two radial recesses, connected to the water port inlet its outlet. At the outlet of water port 9, water flows out through water nozzle 8. Water outflow velocity has a radial component, pointing towards the axis. As an effect of hydrodynamic forces and gas streams flowing out of concentric nozzles, there is a very high dispersion of water particles whilst compact mist stream area of high kinetic energy is retained.

In FIG. 2, the location of manifold is shown. The gas manifold is located in body 1 centre line and two manifold inlet ports are equidistantly spaced on the circumference of the head.

FIG. 3 shows a head version where central nozzle 3 has an annular outlet channel 6. Inside central nozzle 3 divergent-convergent part 2 with cylindrical outside surface on the nozzle outlet is located. Moreover, divergent-convergent part 2 constitutes a circular nozzle with Laval nozzle profile, with an outlet channel with walls parallel to the axis.

In such version of the head, the cross section area of the circular nozzle throat is advantageously equal to the cross section area of central nozzle 3 throat. Deviation of the size limit shall not exceed 0.8 to 1.2 of the nominal dimension. In this head version, the circular nozzle has an outlet to throat cross section ratio of 1.5 to 2.5, expressed by the following formula:

d²/dₒ²=1.5÷2.5

where: d—outlet diameter, dₒ—throat diameter.
Central nozzle 3 has a central annular outlet 6 cross section area to throat cross section area of 5 to 8, expressed by the following formula:

(D₃²−D₃²)/(D₃²−D₂²)=5÷8

where: D₁—outlet inside diameter, D₂—throat diameter, D₃—outlet outside diameter.
Outer annular nozzle 5 has an outlet cross section area to throat cross section area ratio of 1.5 to 2.5, expresses by the following formula:

(D₆²−D₄²)/(D₆²−D₅²)=1.5÷2.5

where: D₄—outlet inside diameter, D⁵—throat diameter, D₆—outlet outside diameter.
Moreover, the cross section area of the outer annular nozzle 5 throat is twice larger than the sum of cross section areas of central nozzle 3 and of circular nozzle throats. The deviation of the size limit should not exceed 0.8 to 1.2 of the nominal size of such cross section area. Cross section areas of circular nozzle throat and central annular nozzle 3 are equal to a tolerance of 20%.
Cross section area of annular nozzle 5 throat is twice larger than the throat cross section area in other nozzles, with a tolerance to within 20%.

In the head, shown in FIG. 3, body 1 is in the shape of a stepped cylinder with male thread on three consecutive steps. The first step, of the smallest diameter, has both male and female thread. Female thread is cut in the axial channel, connected with the gas manifold. Divergent-convergent part 2, provided with its inlet part with holes, through which the gas flows from the axial channel to central nozzle 3 having an annular outlet channel 6, is screwed onto the female thread. The central nozzle is screwed onto the male thread. Onto the next threaded step, sleeve 4 is screwed. Outer annular nozzle 5 is screwed onto the last threaded step. This nozzle is connected, at the inlet by means of a branch union with the axial channel in body 1, connected with the gas manifold. In its divergent-convergent part 2, circular nozzle may be provided with a plug for restricting or closing the cross section of this nozzle outlet channel.

Compressed gas and air in particular, supplied to the gas manifold in the axis of body 1 flows through the axial channel to the circular nozzle and central nozzle 3 and through the means of a branch union to the outer nozzle 5. Arrow P in FIG. 2 indicates air inlet, arrow W indicates water inlet. Water is supplied to water port 9 through the lateral manifold, lateral channel and two radial recesses connected with its inlet. Symmetrical spacing of these recesses around the axis allows appropriate filling of the port throughout its periphery. At the outlet of water port 9, water flows out through water nozzle 8. Water outflow velocity has a radial component pointed towards the axis.

In effect of hydrodynamic forces and gas streams flowing out of concentrically arranged nozzles, very high diffusion of water particles is achieved while retaining a compact area of the generated mist of high kinetic energy. The mass of water mist generated by the head does not consist of water mass only, but also of air mass. Due to that, the kinetic energy of mist generated is increased to such extent that it is possible to direct the front of the mist stream to a distance of 8 to 10 meters, what is a satisfactory distance when extinguishing fires. The effectiveness of the head as per the invention may be improved through the use of additives increasing the density of water, supplied to the head, such like salt solutions, in particular NaCl. Introduction of water solutions or other substances, less volatile that water, to the flame zone improves the effectiveness of extinguishing flames, and evaporated solid particle remaining in the fire area constitute an additional fire suppression agent.

1. Water mist generating head having a twin-flow body, with water and gas manifold, with two gas nozzles, a first central one, and a second annular one concentric to the first one, with an annular water port concentrically disposed between the two gas nozzles, characterised in that the water port /9/ has a water nozzle /8/ at the outlet, convergent towards the axis of the central gas nozzle /3/, and the two gas nozzles, central one and annular gas nozzle /5/, have a Laval nozzle profile with an outlet channel with walls parallel to the axis.

2. Head as claimed in claim 1, characterized in that the water port /9/ is constituted by a sleeve /4/ fixed to the body /1/, being the inner part of the annular gas nozzle /5/.

3. Head as claimed in claim 2, characterized in that the sleeve /4/ is terminated at the outlet with an inside taper convergent towards the axis of central gas nozzle /3/ and cylindrical surface behind the divergent-convergent part formed on the outside surface.

4. Head as claimed in claim 1, characterized in that the water port /9/ has radial channels on the circumference of the inlet part, connected to the water manifold.

5. Head as claimed in claim 4, characterized in that the water manifold has at least two inlet ports, connected with the radial channels via lateral channels.

6. Head as claimed in claim 1, characterized in that the central gas nozzle /3/ has a cylindrical outlet channel behind the convergent-divergent part formed on the inside surface.

7. Head as claimed in claim 1, characterized in that the central gas nozzle /3/ has an annular outlet channel /6/ whilst divergent-convergent part /2/ with cylindrical outside surface at the nozzle outlet is installed concentrically inside the central gas nozzle /3/.

8. Head as claimed in claim 7, characterized in that the divergent-convergent part /2/ constituting a circular nozzle with Laval nozzle profile, with outlet channel having wall parallel to the axis.

9. Head as claimed in claim 8, characterized in that the cross section area of circular nozzle throat is advantageously equal to cross section area of the central gas nozzle /3/ throat, with a tolerance of 0.8 to 1.2 of cross section area.

10. Head as claimed in claim 8, characterized in that the circular nozzle throat has outlet cross section area to throat cross section ratio of 1.5 to 2.5, the central gas nozzle /3/ has an annular outlet channel /6/ outlet to throat cross section ratio of 5 to 8, and the annular nozzle /5/ has an outlet to throat cross section area ratio of 1.5 to 2.5.

11. Head as claimed in claim 8, characterized in that the cross section area of the annular nozzle /5/ throat is advantageously twice the sum of cross section areas of central gas nozzle /3/ throat and circular nozzle, with a tolerance of 0.8 to 1.2 of cross section area.

12. Head as claimed in claim 2, characterized in that the central gas nozzle /3/ and the annular gas nozzle /5/ have a cross section area ratio of the outlet to throat of 1.5 to 2.5.

13. Head as claimed in claim 2, characterized in that the cross section areas of the annular gas nozzle /5/ throat and the central gas nozzle /3/ are advantageously equal, with a tolerance of 0.8 to 1.2 of cross section area.
